(19) United States
(12) Patent Application Publication
(10) Pub. No.: US 2025/0155726 A1
(43) Pub. Date: May 15, 2025

(54) HOLOGRAM PROJECTION DEVICE

(71) Applicant: DARWIN PRECISIONS CORPORATION, Hsinchu County (TW)

(72) Inventors: SYUAN-WEI JHANG, Hsinchu County (TW); CHIH-PING HSU, Hsinchu County (TW); YA HAN KO, Hsinchu County (TW)

(21) Appl. No.: 18/940,894

(22) Filed: Nov. 8, 2024

(30) Foreign Application Priority Data
Nov. 10, 2023 (TW) 112143451

(51) Int. Cl. G02B 30/56

(52) U.S. Cl. CPC G02B 30/56

(57) ABSTRACT

A hologram projection device includes the following features. A display assembly has a display surface adapted to generate collimated image light meeting one of the following conditions. In a condition 1, full widths at half maximum of the collimated image light at the horizontal viewing angle and the vertical viewing angle are less than or equal to 35°. In a condition 2, luminance of the collimated image light within a range of the full widths at half maximum larger than or equal to 45° are less than or equal to 2% of a maximum luminance. A reflective assembly is disposed on a transmission path of the collimated image light and includes a light-transmitting substrate and reflective elements. The light-transmitting substrate is inclined relative to the display surface. The reflective elements are disposed on the light-transmitting substrate and adapted to reflect the collimated image light to a projection position.

### CROSS-REFERENCE TO RELATED APPLICATIONS

This application claims priority to Taiwanese Application No. 112143451, filed on Nov. 10, 2023, which is hereby incorporated by reference for all purposes as if fully set forth herein.

### FIELD OF THE INVENTION

The present invention relates to a projection device, and more particularly to a hologram projection device.

### BACKGROUND OF THE INVENTION

The hologram projection technology is able to project a stereoscopic image to the air, so that the stereoscopic image shows an effect of floating in the air. In addition, special effects such as rotation, movement or zooming are able to be added to the stereoscopic images according to the requirements in practice, and visual effects can be additionally added. Therefore, the hologram projection technology is very suitable for use in the occasions such as commodity display, entertainment performances, etc. However, a stereoscopic image projected by a conventional hologram projection device is often accompanied with noisy images that usually occur on two sides of the stereoscopic image, thereby affecting the viewing experience.

### SUMMARY OF THE INVENTION

The present invention provides a hologram projection device, to resolve the problem of noisy images.

To achieve one, part or all of the above objectives or other objectives, the hologram projection device provided by the present invention includes a display assembly and a reflective assembly. The display assembly has a display surface, and the display surface has a horizontal viewing angle and a vertical viewing angle. The display assembly is adapted to generate collimated image light meeting a condition 1 or a condition 2. In the condition 1, a first full width at half maximum of the collimated image light at the horizontal viewing angle is less than or equal to 35°, and a second full width at half maximum of the collimated image light at the vertical viewing angle is less than or equal to 35°. In the condition 2, the collimated image light has a first luminance within a range of the first full width at half maximum of larger than or equal to 45°, and the collimated image light has a second luminance within a range of the second full width at half maximum of larger than or equal to 45°. The first luminance and the second luminance are less than or equal to 2% of a maximum luminance of the collimated image light. The reflective assembly is disposed on a transmission path of the collimated image light. The reflective assembly includes a light-transmitting substrate and a plurality of reflective elements. The light-transmitting substrate is inclined relative to the display surface. The reflective elements are disposed on the light-transmitting substrate, and the reflective elements are adapted to reflect the collimated image light to a projection position.

In an embodiment of the present invention, the display assembly includes, for example, a light source module, a collimation module, and a display panel. The light source module is disposed opposite to the display panel, and the collimation module is disposed between the light source module and the display panel. The display surface is located on a side of the display panel facing away from the collimation module. The collimation module is adapted to transform light generated by the light source module to collimated light, and the display panel is adapted to transform the collimated light to the collimated image light.

In an embodiment of the present invention, the light source module may include a plurality of light-emitting elements, and the collimation module may include a plurality of collimating lenses. Each of the collimating lenses is disposed opposite to each of the light-emitting elements.

In an embodiment of the present invention, the light-emitting elements respectively have top surfaces, and the top surfaces respectively face toward the collimating lenses. The top surfaces are spaced apart from the collimating lenses by gaps of, for example, less than or equal to 50 mm.

In an embodiment of the present invention, the display assembly may include a light source module, a light guide plate, a reverse prism sheet, and a display panel. The light guide plate has a light incident surface and a light-emitting surface connected to the light incident surface. The light source module is opposite to the light incident surface, and the reverse prism sheet is opposite to the light-emitting surface. The display panel is disposed on a side of the reverse prism sheet facing away from the light-emitting surface, and the display surface is located on a side of the display panel facing away from the reverse prism sheet. The light source module is adapted to generate a light beam, and the light guide plate is adapted to guide the light beam to be emitted from the light-emitting surface at a light-emitting angle ranging from 55° to 80°.

In an embodiment of the present invention, the light guide plate further has a bottom surface. The bottom surface is opposite to the light-emitting surface, and the bottom surface has a plurality of light-scattering microstructures. Each of the light-scattering microstructures has a first surface and a second surface. The first surfaces and the second surfaces are connected to the bottom surface. The first surfaces face toward a side of the light guide plate having the light incident surface, and the second surfaces face away from the side of the light guide plate having the light incident surface. A first included angle is between each of the first surfaces and the bottom surface, and a second included angle is between each of the second surfaces and the bottom surface. Each of the first included angles is, for example, less than each of the second included angles.

In an embodiment of the present invention, the reverse prism sheet may include a plate body and a plurality of prisms. The prisms are located on a surface of the plate body facing toward the light guide plate, and an axial direction of each of the prisms extends along the surface. A side of each of the prisms facing away from the plate body has a top corner, and an angle of each of the top corners ranges, for example, from 60° to 75°.

In an embodiment of the present invention, the plate body further has a first side surface and a second side surface. The first side surface and the second side surface are located on two opposite sides of the surface, and the first side surface and the second side surface are opposite to each other. The first side surface is closer to the light source module than the second side surface. Each of the prisms includes a triangular prism, and each of the prisms further has a first bottom corner and a second bottom corner both connected to the surface. Each of the first bottom corners is closer to the first side surface than each of the second bottom corners, and an angle of each of the first bottom corners may be larger than or equal to an angle of each of the second bottom corners.

In an embodiment of the present invention, the hologram projection device further includes a grating. The grating is disposed opposite to the display surface, and the grating is adapted to transform image light emitted by the display surface to the collimated image light.

In an embodiment of the present invention, the reflective assembly includes a dihedral corner reflector array. The reflective elements respectively include a plurality of micro reflectors. The micro reflectors stand on the light-transmitting substrate, and the micro reflectors are adapted to reflect the collimated image light to the projection position.

The display assembly used in the hologram projection device according to the present invention is able to generate the collimated image light, and the collimated image light meets the condition 1 or the condition 2. In detail, the display assembly is able to reduce the first full width at half maximum of the collimated image light and the second full width at half maximum of the collimated image light to a range of less than or equal to 35°, or reduce the first luminance of the collimated image light and the second luminance of the collimated image light to less than or equal to 2% of the maximum luminance. Therefore, it can be ensured that most of the collimated image light is projected to the projection position by twice reflection of the reflective element when passing through the reflective assembly, thereby reducing noisy images formed by once reflection of the reflective element. Based on the above, the hologram projection device according to the present invention is able to effectively resolve the problem of noisy images.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The present invention will become more readily apparent to those ordinarily skilled in the art after reviewing the following detailed description and accompanying drawings, in which:

FIG. 1 is a schematic diagram of a hologram projection device according to an embodiment of the present invention;

FIG. 2 is a schematic diagram of a relationship between luminance of the collimated image light at a horizontal viewing angle and the horizontal viewing angle in FIG. 1;

FIG. 3 is a schematic diagram of a relationship between luminance of the collimated image light at a vertical viewing angle and the vertical viewing angle in FIG. 1;

FIG. 4 is a schematic diagram of forming an image by the reflective assembly in FIG. 1;

FIG. 5 is a schematic diagram of a light beam being reflected to a projection position by the reflective element in FIG. 4;

FIG. 6 is a schematic diagram of a display assembly in FIG. 1;

FIG. 7 is a schematic diagram of a display assembly of a hologram projection device according to another embodiment of the present invention;

FIG. 8 is a schematic partial enlarged view of a light guide plate in FIG. 7;

FIG. 9 is a schematic partial enlarged view of a reverse prism sheet in FIG. 7; and

FIG. 10 is a schematic diagram of a display assembly of a hologram projection device according to another embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

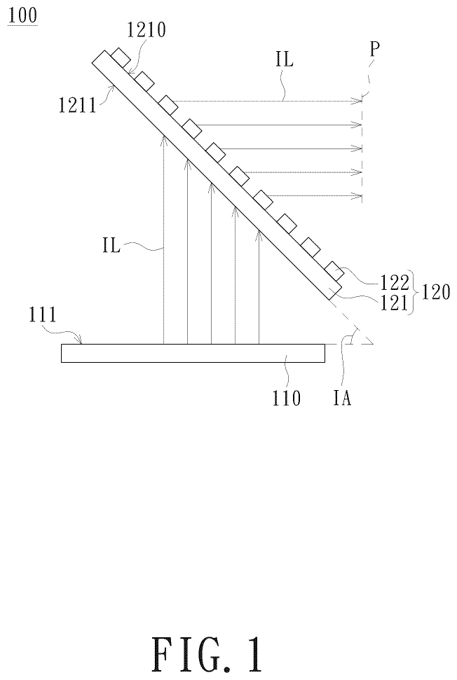

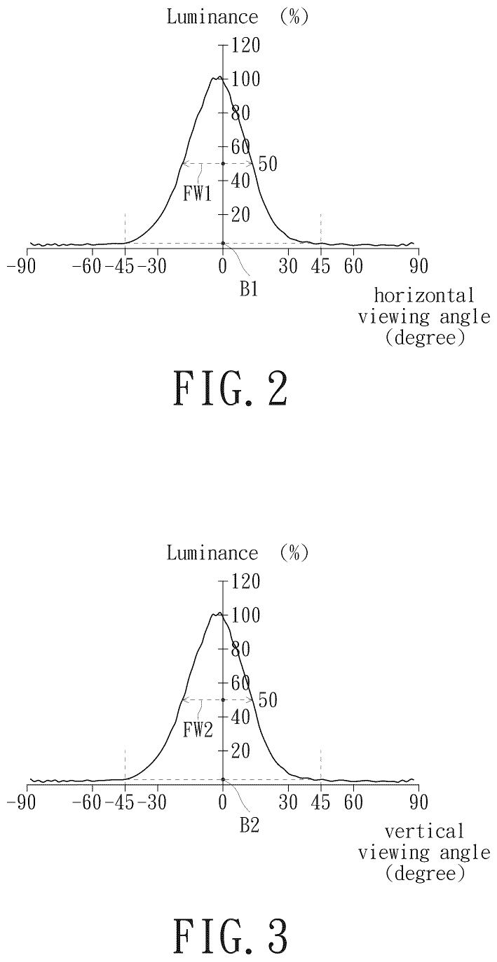

FIG. 1 is a schematic diagram of a hologram projection device according to an embodiment of the present invention. FIG. 2 is a schematic diagram of a relationship between luminance of the collimated image light at a horizontal viewing angle and the horizontal viewing angle in FIG. 1. FIG. 3 is a schematic diagram of a relationship between luminance of the collimated image light at a vertical viewing angle and the vertical viewing angle in FIG. 1. Referring to FIG. 1 first, a hologram projection device 100 includes a display assembly 110 and a reflective assembly 120. The display assembly 110 has a display surface 111, and the display surface 111 has a horizontal viewing angle and a vertical viewing angle. The display assembly 110 is adapted to generate collimated image light IL meeting a condition 1 or a condition 2. Referring to FIG. 2 and FIG. 3 together, in the condition 1, a first full width FW1 at half maximum of the collimated image light IL at the horizontal viewing angle is less than or equal to 35°, and a second full width FW2 at half maximum of the collimated image light IL at the vertical viewing angle is less than or equal to 35°. In the condition 2, the collimated image light IL has a first luminance B1 within a range of the first full width FW1 at half maximum of larger than or equal to 45°, and the collimated image light IL has a second luminance B2 within a range of the second full width FW2 at half maximum of larger than or equal to 45°. The first luminance B1 and the second luminance B2 are less than or equal to 2% of a maximum luminance (that is 100%) of the collimated image light IL. Referring to FIG. 1 again, the reflective assembly 120 is disposed on a transmission path of the collimated image light IL. The reflective assembly 120 has a light-transmitting substrate 121 and a plurality of reflective elements 122. The light-transmitting substrate 121 is inclined relative to the display surface 111. The reflective elements 122 are disposed on the light-transmitting substrate 121, and the reflective elements 122 are adapted to reflect the collimated image light IL to a projection position P.

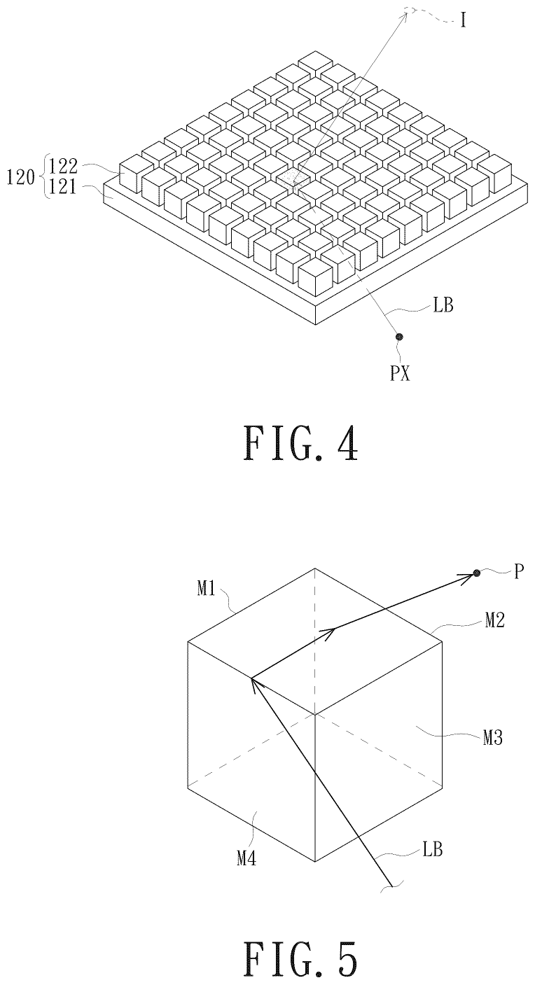

FIG. 4 is a schematic diagram of forming an image by the reflective assembly in FIG. 1. FIG. 5 is a schematic diagram of a light beam being reflected to a projection position by the reflective element in FIG. 4. Referring to FIG. 4 and FIG. 5 together, the reflective assembly 120 may include a dihedral corner reflector array (DCRA). Each of the reflective elements 122 includes micro reflectors M1, M2, M3, and M4 (all marked in FIG. 5). The micro reflectors M1, M2, M3, and M4 stand on the light-transmitting substrate 121, and the micro reflectors M1, M2, M3, and M4 are adapted to reflect the collimated image light IL (drawn in FIG. 1) to the projection position P. In detail, when a light beam LB generated by pixels PX passes through the reflective element 122, the light beam LB will be sequentially reflected by the micro reflectors M1 and M2, thereby forming an image I (marked in FIG. 4) at the projection position P. In other words, the light beam LB is reflected twice when passing through the reflective element 122, and then reaches the projection position P.

It should be noted that, part of the light beam LB entering the reflective element 122 may be reflected once and then emitted from the reflective element 122 in the prior art. For example, part of the light beam LB is emitted from the reflective element 122 after being reflected by the micro reflector M1. Since a transmission path of the light beam (not shown in a figure) being reflected once is different from a transmission path of the light beam LB being reflected twice, the light beam reflected once cannot be accurately transmitted to the projection position P, but forms a noisy image in the vicinity of the projection position P. However, as shown in FIG. 1, because the hologram projection device 100 in this embodiment uses the display assembly 110 capable of generating the collimated image light IL, it can be ensured that most of the light beam LB is reflected twice before being emitted from the reflective element 122 when passing through the reflective element 122, thereby resolving the problem of noisy images in the prior art.

In an embodiment, an included angle IA between the light-transmitting substrate 121 and the display surface 111 may be approximately 45°, but is not limited by the present invention. Incidentally, the light-transmitting substrate 121 in this embodiment may have surfaces 1210 and 1211 opposite to each other, wherein the surface 1210 faces away from the display assembly 110, and the reflective element 122 may stand on the surface 1210. However, the reflective element 122 may stand on the surface 1211, or on the surfaces 1210 and 1211 in an embodiment.

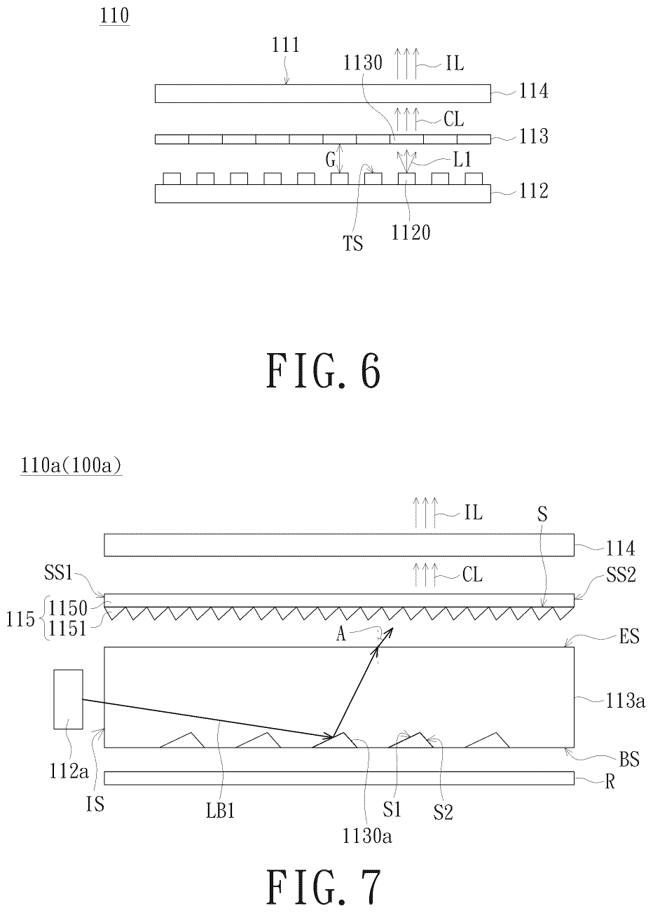

FIG. 6 is a schematic diagram of a display assembly in FIG. 1. Referring to FIG. 6, the display assembly 110 in this embodiment may include a liquid crystal display assembly, but other embodiments are not limited thereto. The display assembly 110 includes, for example, a light source module 112, a collimation module 113, and a display panel 114 in this embodiment. The light source module 112 is disposed opposite to the display panel 114, and the collimation module 113 is disposed between the light source module 112 and the display panel 114. The display surface 111 is located on a side of the display panel 114 facing away from the collimation module 113. The collimation module 113 is adapted to transform light L1 generated by the light source module 112 to collimated light CL, and the display panel 114 is adapted to transform the collimated light CL to the collimated image light IL. Specifically, the light L1 generated by the light source module 112 is, for example, divergent light, and the collimation module 113 may transform the light L1 to the collimated light CL meeting the condition 1 or the condition 2. In addition, the display panel 114 can transform the collimated light CL to the collimated image light IL, and the collimated image light IL is emitted from the display surface 111. The display panel 114 is, for example, a liquid crystal display panel in this embodiment, but the present invention is not limited thereto.

The light source module 112 in this embodiment may include a plurality of light-emitting elements 1120, and the collimation module 113 may include a plurality of collimating lenses 1130. Each of the collimating lenses 1130 is disposed opposite to each of the light-emitting elements 1120. For example, the light-emitting elements 1120 may be disposed in an array on the substrate, and the collimating lenses 1130 may be disposed in an array, with each collimating lens 1130 disposed opposite to each light-emitting element 1120. Each collimating lens 1130 includes, for example, a Fresnel lens in this embodiment, but the present invention is not limited thereto. Additionally, each light-emitting element 1120 in this embodiment may include a light-emitting diode (LED), but other embodiments are not limited thereto. Incidentally, the light-emitting elements 1120 respectively have top surfaces TS in this embodiment, and the top surfaces TS respectively face toward the collimating lenses 1130. The top surfaces TS are respectively spaced apart from the collimating lenses 1130 by gaps G of, for example, less than or equal to 50 mm. In this way, the collimating effect of the collimating lenses 1130 on the light L1 can be further improved.

Compared with the prior art, the display assembly 110 used in the hologram projection device 100 in this embodiment is able to generate the collimated image light IL, and the collimated image light IL meets the condition 1 or the condition 2. In detail, the display assembly 110 is able to reduce the first full width FW1 at half maximum of the collimated image light IL and the second full width FW2 at half maximum of the collimated image light IL to a range of less than or equal to 35°, or reduce the first luminance B1 of the collimated image light IL and the second luminance B2 of the collimated image light IL to less than or equal to 2% of the maximum luminance. Therefore, it can be ensured that most of the collimated image light IL is projected to the projection position P by twice reflection of the reflective element 122 when passing through the reflective assembly 120, thereby reducing noisy images formed by once reflection of the reflective element 122. Based on the above, the hologram projection device 100 in this embodiment is able to effectively resolve the problem of noisy images I.

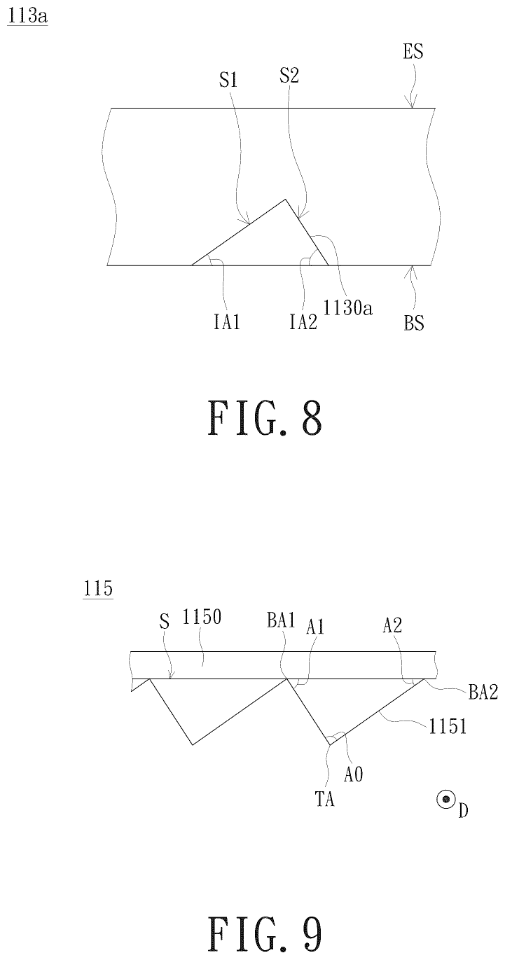

FIG. 7 is a schematic diagram of a display assembly of a hologram projection device according to another embodiment of the present invention. FIG. 8 is a schematic partial enlarged view of a light guide plate in FIG. 7. FIG. 9 is a schematic partial enlarged view of a reverse prism sheet in FIG. 7. The structure and advantages of a hologram projection device 100a in this embodiment are similar to those in the embodiment in FIG. 1, and only the differences will be described below. Referring to FIG. 7 first, a display assembly 110a may include a light source module 112a, a light guide plate 113a, a display panel 114, and a reverse prism sheet 115. The light guide plate 113a has a light incident surface IS and a light-emitting surface ES connected to the light incident surface IS. The light source module 112a is opposite to the light incident surface IS, and the reverse prism sheet 115 is opposite to the light-emitting surface ES. The display panel 114 is disposed on a side of the reverse prism sheet 115 facing away from the light-emitting surface ES, and the display surface 111 is located on a side of the display panel 114 facing away from the reverse prism sheet 115. The light source module 112a is adapted to generate a light beam LB1, and the light guide plate 113a is adapted to guide the light beam LB1 to be emitted from the light-emitting surface ES at a light-emitting angle A ranging from 55° to 80°. Specifically, the light beam LB1 emitted from the light-emitting surface ES enters the reverse prism sheet 115, and the reverse prism sheet 115 can guide the light beam LB1 to be approximately emitted forwards, thereby transforming a plurality of the light beams LB1 to the collimated light CL. Similarly, the collimated light CL meets the condition 1 or the condition 2, and the display panel 114 can transform the collimated light CL to the collimated image light IL.

Referring to FIG. 7 and FIG. 8, furthermore, the light guide plate 113a further has a bottom surface BS. The bottom surface BS is opposite to the light-emitting surface ES, and the bottom surface BS has a plurality of light-scattering microstructures 1130a. Each of the light-scattering microstructures 1130a has a first surface S1 and a second surface S2. The first surfaces S1 and the second surfaces are connected to the bottom surface BS. The first surfaces S1 face toward a side of the light guide plate 113a having the light incident surface IS, and the second surfaces S2 face away from the side of the light guide plate 113a having the light incident surface IS. A first included angle IA1 (marked in FIG. 8) is between each of the first surfaces S1 and the bottom surface BS, and a second included angle IA2 (marked in FIG. 8) is between each of the second surfaces S2 and the bottom surface BS. Each of the first included angles IA1 is, for example, less than each of the second included angles IA2. Therefore, the first surface S1 can guide the light beam LB1 to be emitted from the light-emitting surface ES at the light-emitting angle A ranging from 55° to 80°. In other words, a grade of the first surface S1 relative to the bottom surface BS may be less than a grade of the second surface S2 relative to the bottom surface BS, and most of the light beams LB1 entering the light-scattering microstructures 1130a are reflected to the light-emitting surface ES by the first surface S1. The first included angle IA1 may be, for example, approximately between 15° and 45°, and the second included angle IA2 may be approximately between 30° and 75° in an embodiment, but the specific values are not limited by the present invention.

Referring to FIG. 7 and FIG. 9, the reverse prism sheet 115 may include a plate body 1150 and a plurality of prisms 1151 in this embodiment. The prisms 1151 are located on a surface S of the plate body 1150 facing toward the light guide plate 113a, and an axial direction D (drawn in FIG. 9) of each of the prisms 1151 extends along the surface S. A side of each of the prisms 1151 facing away from the plate body 1150 has a top corner TA, and each of the top corners TA has an angle A0 ranging, for example, from 60° to 75°. In this way, the prisms 1151 can guide the light beams LB1 to be more approximately emitted forwards, thereby further improving the collimating effect of the reverse prism sheet 115 on the light beams LB1. On the other hand, the plate body 1150 further has a first side surface SS1 and a second side surface SS2 (both marked in FIG. 7). The first side surface SS1 and the second side surface SS2 are located on two opposite sides of the surface S, and the first side surface SS1 and the second side surface SS2 are opposite to each other. The first side surface SS1 is closer to the light source module 112a than the second side surface SS2. Each of the prisms 1151 includes a triangular prism, and each of the prisms 1151 further has a first bottom corner BA1 and a second bottom corner BA2 (both marked in FIG. 9) both connected to the surface S. Each of the first bottom corners BA1 is closer to the first side surface SS1 than each of the second bottom corners BA2, and an angle A1 of each of the first bottom corners BA1 may be larger than or equal to an angle A2 of each of the second bottom corners BA2, so as to improve the light emitting uniformity of the reverse prism sheet 115. For example, the angle A1 may be larger than the angle A2 in this embodiment. The angles A1 and A2 may be approximately between 50° and 70° in an embodiment, but the specific values are not limited by the present invention.

Continuing referring to FIG. 7, incidentally, the features of the light source module 112a in this embodiment are the same as those of the light source module 112 in FIG. 6, so relevant description is omitted herein. Additionally, the display assembly 110a may further include a reflective plate R. The reflective plate R may be disposed opposite to the bottom surface BS, so as to improve the light utilization of the display assembly 110a. A material of the reflective plate R includes, for example, silver, but is not limited by the present invention.

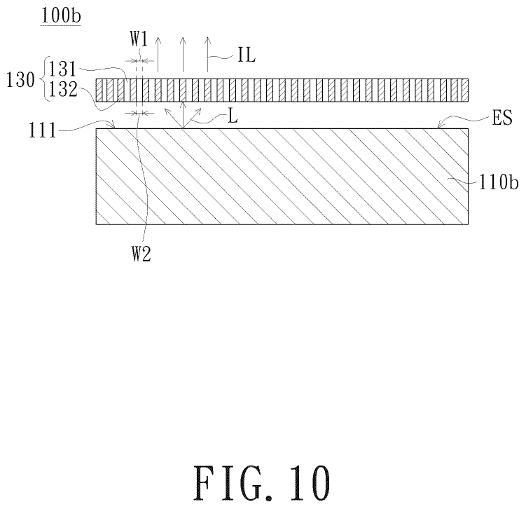

FIG. 10 is a schematic diagram of a display assembly of a hologram projection device according to another embodiment of the present invention. The structure and advantages of a hologram projection device 100b in this embodiment are similar to those in the embodiment in FIG. 1, and only the differences will be described below. Referring to FIG. 10, a hologram projection device 100b further includes, for example, a grating 130. The grating 130 is disposed opposite to the display surface 111, and the grating 130 is adapted to transform light L emitted by the display surface 111 to the collimated image light IL. In detail, the light L generated by the display surface 111 does not meet, for example, the condition 1 and the condition 2, and the grating 130 can transform the light L to the collimated image light IL. A display assembly 110b may include a liquid crystal display assembly in this embodiment, but other embodiments are not limited thereto. Incidentally, the grating 130 may have a light-transmitting part 131 and a light-blocking part 132, wherein a side of the light-transmitting part 131 facing away from the light-emitting surface ES has a width W1, and a side of the light-transmitting part 131 facing toward the light-emitting surface ES has a width W2. The widths W1 and W2 are, for example, approximately the same in this embodiment, while the width W1 may be larger than the width W2 in an embodiment. In other words, the light-transmitting part 131 may be trapezoidal in shape in an embodiment. However, the detailed features of the light-transmitting part 131 and the light-blocking part 132 are not limited by the present invention.

In summary, the display assembly used in the hologram projection device according to the present invention is able to generate the collimated image light, and the collimated image light meets the condition 1 or the condition 2. In detail, the display assembly is able to reduce the first full width at half maximum of the collimated image light and the second full width at half maximum of the collimated image light to a range of less than or equal to 35°, or reduce the first luminance of the collimated image light and the second luminance of the collimated image light to less than or equal to 2% of the maximum luminance. Therefore, it can be ensured that most of the collimated image light is projected to the projection position by twice reflection of the reflective element when passing through the reflective element, thereby reducing noisy images formed by once reflection of the reflective element. Based on the above, the hologram projection device according to the present invention is able to effectively resolve the problem of noisy images.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A hologram projection device, comprising:
a display assembly, having a display surface, the display surface having a horizontal viewing angle and a vertical viewing angle, the display assembly being adapted to generate collimated image light meeting the following condition:
a condition 1: a first full width at half maximum of the collimated image light at the horizontal viewing angle being less than or equal to 35°, and a second full width at half maximum of the collimated image light at the vertical viewing angle being less than or equal to 35°; or
a condition 2: the collimated image light having a first luminance within a range of the first full width at half maximum of larger than or equal to 45°, and the collimated image light having a second luminance within a range of the second full width at half maximum of larger than or equal to 45°, the first luminance and the second luminance being respectively less than or equal to 2% of a maximum luminance of the collimated image light; and
a reflective assembly, disposed on a transmission path of the collimated image light, the reflective assembly having a light-transmitting substrate and a plurality of reflective elements, the light-transmitting substrate being inclined relative to the display surface, the reflective elements are disposed on the light-transmitting substrate, and the reflective elements being adapted to reflect the collimated image light to a projection position.

2. The hologram projection device according to claim 1, wherein the display assembly comprises a light source module, a collimation module, and a display panel, the light source module is disposed opposite to the display panel, and the collimation module is disposed between the light source module and the display panel, the display surface is located on a side of the display panel facing away from the collimation module, the collimation module is adapted to transform light generated by the light source module to collimated light, and the display panel is adapted to transform the collimated light to the collimated image light.

3. The hologram projection device according to claim 2, wherein the light source module comprises a plurality of light-emitting elements, the collimation module comprises a plurality of collimating lenses, and each of the collimating lenses is disposed opposite to each of the light-emitting elements.

4. The hologram projection device according to claim 3, wherein the light-emitting elements respectively have top surfaces, and the top surfaces respectively face toward the collimating lenses, the top surfaces are respectively spaced apart from the collimating lenses by gaps of less than or equal to 50 mm.

5. The hologram projection device according to claim 1, wherein the display assembly comprises a light source module, a light guide plate, a reverse prism sheet, and a display panel, the light guide plate has a light incident surface and a light-emitting surface connected to the light incident surface, the light source module is opposite to the light incident surface, the reverse prism sheet is opposite to the light-emitting surface, the display panel is disposed on a side of the reverse prism sheet facing away from the light-emitting surface, the display surface is located on a side of the display panel facing away from the reverse prism sheet, the light source module is adapted to generate a light beam, and the light guide plate is adapted to guide the light beam to be emitted from the light-emitting surface at a light-emitting angle ranging from 55° to 80°.

6. The hologram projection device according to claim 5, wherein the light guide plate further has a bottom surface, the bottom surface is opposite to the light-emitting surface, and the bottom surface has a plurality of light-scattering microstructures, each of the light-scattering microstructures has a first surface and a second surface, the first surfaces and the second surfaces are connected to the bottom surface, the first surfaces face toward a side of the light guide plate having the light incident surface, and the second surfaces face away from the side of the light guide plate having the light incident surface, a first included angle is between each of the first surfaces and the bottom surface, and a second included angle is between each of the second surfaces and the bottom surface, and each of the first included angles is less than each of the second included angles.

7. The hologram projection device according to claim 5, wherein the reverse prism sheet comprises a plate body and a plurality of prisms, the prisms are located on a surface of the plate body facing toward the light guide plate, and an axial direction of each of the prisms extends along the surface, a side of each of the prisms facing away from the plate body has a top corner, and an angle of each of the top corners ranges from 60° to 75°.

8. The hologram projection device according to claim 7, wherein the plate body further has a first side surface and a second side surface, the first side surface and the second side surface are located on two opposite sides of the surface, and the first side surface and the second side surface are opposite to each other, the first side surface is closer to the light source module than the second side surface, each of the prisms comprises a triangular prism, and each of the prisms further has a first bottom corner and a second bottom corner both connected to the surface, each of the first bottom corners is closer to the first side surface than each of the second bottom corners, and an angle of each of the first bottom corners is larger than or equal to an angle of each of the second bottom corners.

9. The hologram projection device according to claim 1, further comprising a grating, wherein the grating is disposed opposite to the display surface, and the grating is adapted to transform image light emitted by the display surface to the collimated image light.

10. The hologram projection device according to claim 1, wherein the reflective assembly comprises a dihedral corner reflector array, the reflective elements respectively comprise a plurality of micro reflectors, the micro reflectors stand on the light-transmitting substrate, and the micro reflectors are adapted to reflect the collimated image light to the projection position.
